(19) United States
(12) Patent Application Publication
(10) Pub. No.: US 2004/0098300 A1
(43) Pub. Date: May 20, 2004

(54) Method, system, and storage medium for optimizing project management and quality assurance processes for a project

(75) Inventors: Chester Dennis Karwatowski, West Shokan, NY (US); Randolph Bruce Kathmann, Fishkill, NY (US); Robert Angelo Silveri, Hopewell Junction, NY (US); Donald Ivan Stanton, Monroe, NY (US)

Correspondence Address: Philmore H. Colburn II, CANTOR COLBURN LLP, 55 Griffin Road South, Bloomfield, CT, 06002, US

(73) Assignee: International Business Machines Corporation, Armonk, NY

(21) Appl. No.: 10/300,050

(22) Filed: Nov. 19, 2002

(51) Int. Cl. G06F 17/60

(52) U.S. Cl. 705/11

(57) ABSTRACT

An exemplary embodiment of the invention relates to a method, system, and storage medium for optimizing project management and quality assurance processes for a project. The method comprises performing risk assessment analysis on project data utilizing pre-established risk criteria. If the results of the risk assessment analysis indicate a project exceeds a pre-defined risk threshold: performing a project review assessment utilizing pre-established assessment criteria; generating a summary review including analysis data, conclusion data, and recommendations data based upon the results of the project review assessment; transmitting summary review information to designated management personnel; implementing the project; documenting project execution data; and storing the project execution data in a storage location. Other embodiments include a system and storage medium for implementing the invention.

### BACKGROUND

This invention relates generally to project management, and more particularly, the present invention relates to a method, system, and storage medium for optimizing project management and quality assurance processes for a project.

A project has been defined as a specific set of activities, undertaken to meet one or more established goals or objectives, within defined constraints of scope, quality, time, cost, and stakeholder satisfaction. The field of project management refers to the process of planning, organizing, staffing, directing and controlling the production of a project. The ultimate success of a project depends upon the project management process(es) utilized and the value or gains derived therefrom in terms of the end product or result. Project management can be a difficult and challenging endeavor, particularly for large and complex projects. Some of the most commonly reported challenges faced by project management teams include difficulties in controlling the project's costs, scope, and scheduling requirements, as well as dealing with difficult clients. Project teams frequently find themselves faced with urgent deadlines, insufficient resources, a limited appreciation for the potential risks, and a lack of organization. Measuring the quality of the processes in a precise and systematic fashion, both during and after the project's execution, has also been a major concern to modern businesses.

What is needed is a process to improve the success and quality of projects in an optimized and self-correcting manner that is suited for multi-project and/or multi-subproject environments.

### SUMMARY

An exemplary embodiment of the invention relates to a method, system, and storage medium for optimizing project management and quality assurance processes for a project. The method comprises performing risk assessment analysis on project data utilizing pre-established risk criteria. If the results of the risk assessment analysis indicate a project exceeds a pre-established risk threshold: performing a project review assessment utilizing pre-established assessment criteria; generating a summary review including analysis data, conclusion data, and recommendations data based upon the results of the project review assessment; transmitting summary review information to designated management personnel; implementing the project; documenting project execution data; and storing the project execution data in a storage location. Other embodiments include a system and storage medium for implementing the invention.

### BRIEF DESCRIPTION OF THE DRAWINGS

Referring now to the drawings wherein like elements are numbered alike in the several FIGURES:

FIG. 1 is a block diagram of a system for implementing the project management optimization system in an exemplary embodiment;

FIG. 2 is a flowchart illustrating the process for implementing the project management optimization system in an exemplary embodiment;

FIG. 3 is a diagram of a complexity/maturity grid utilized by the project management optimization system in an exemplary embodiment;

FIG. 4 is a flowchart illustrating the process for continuously improving quality measurements in an exemplary embodiment;

FIG. 5 is a sample set of critical sub-processes and corresponding measures of in-process quality criteria utilized by the project management optimization system in an exemplary embodiment.

### DESCRIPTION OF THE PREFERRED EMBODIMENT

The project management optimization system of the invention relates to a system and process for improving the success and quality of projects by using an integrated management system with appropriate quality assurance procedures, to assess and act on identified risks in an optimized, self-correcting, and feed-forward manner in a multi-project or multi-subproject environment.

The project management optimization system is designed to improve the execution of the project management process and ultimately the success of the projects for which it is applied. It does this by creating a closed loop process that feeds back defect information on a continuous basis and initiating a set of direct actions to eliminate the defect from reoccurring. This closed loop process eliminates known defects or continues to feed them back until proper corrective action removes them.

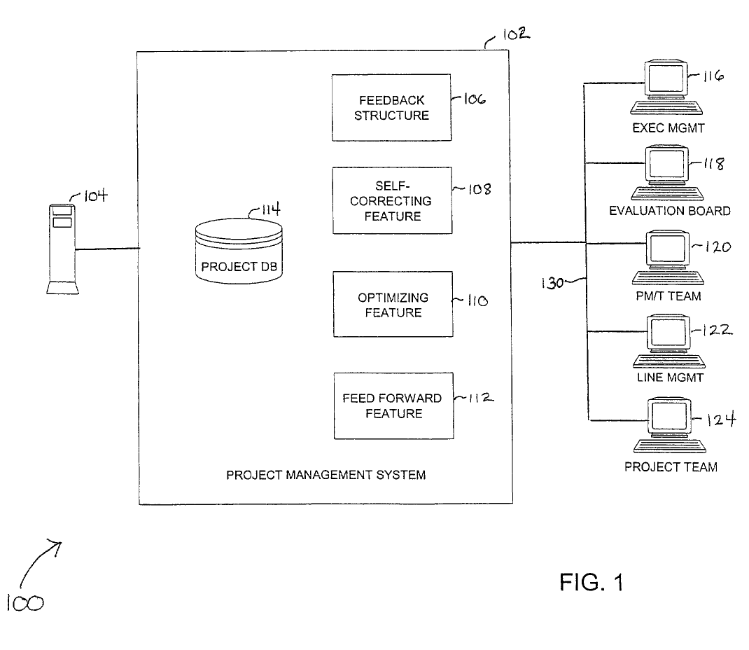

In an exemplary embodiment, the project management optimization system 102 is implemented via a network system such as that depicted in FIG. 1. System 100 may be part of a wide area network including multiple geographical locations that are interconnected by high-speed data lines or radio links. In the simplified diagram of FIG. 1, system 100 represents a business enterprise operating in a client/server architecture mode via server 104, a network 130 and client systems 116-124. Server 104 includes internal storage for receiving data and allowing client systems 116-124 to access information stored therein. It is important to note that the data storage element of server 104 need not be internal, but may comprise an external data storage device as is known in the art. Client systems 116-124 represent computer workstations operated by representatives of the business enterprise. These representatives include executive management personnel, evaluation board members, project teams, line management personnel, and project management/technical (PM/T) teams.

One or more individuals from the executive management team, the evaluation board, PM/T team, line management, and project team transmit and retrieve information from server 104 via client systems 116-124 respectively.

Executive management personnel refers to individuals responsible for making decisions regarding which projects should be approved for implementation. Such decisions are typically based upon business considerations.

Evaluation board members are assigned by the business enterprise to provide an ongoing function to establish and maintain the technical and architectural strategy plans. They are charged with the responsibility of evaluating, from a technical perspective, where and how projects fit in to the enterprise's plans. In this process they are also responsible for assessing the risks of new projects based upon a determination of their complexity and skills/experience requirements.

The PM/T team is an ad hoc team composed of individuals recognized for their knowledge, experience, and competence in project management implementation and in-depth understanding of the technologies used by the enterprise. In this process they perform specific assessment reviews based upon projected risks associated with the organization's projects and develop appropriate conclusions and recommendations.

Line management personnel are responsible for the management of the project. The ultimate responsibility and accountability for the results reside with these individuals. Line management is further responsible for conducting periodic reviews and taking measurements relating to the status and quality of projects.

It should be noted that any number of client systems may be utilized by the business enterprise. For purposes of illustration, only five client systems 116-124 are shown. Each of client systems 116-124 may comprise a web-enabled personal computing device such as a desktop, laptop, or other similar apparatus known in the art. The term “business enterprise” refers to the organization implementing the project management optimization system 102 of the invention.

Network 130 may comprise a LAN, a WAN, or other network configuration known in the art. Network 130 may include wireless technology, radio-based communications, telephony-based communications, or a combination of the above. For purposes of illustration, however, network 130 is a LAN Intranet. Access is limited to internal devices and applications through a firewall or similar security system (not shown) which protects system 100 from unauthorized access. The business enterprise preferably executes suitable multi-platform supported server software for creating secure, interactive Internet, Intranet, and Extranet applications, and which allows information stored in server 104 to be managed and presented to end users such as client systems 116-124 via business applications utilizing data management components (e.g., IBM's DB2™) as well as a presentation component (e.g., Lotus Domino™). System 100 executes the project management optimization system 102, among other applications via server 104, client systems 116-124, or a combination of the above. Server 104 allows the business enterprise to maintain up-to-date information about new and existing projects and the efficacy of the project management optimization system process in a real-time environment through its replication features and web browsers. Server 104 shares information with client systems 116-124, storing the most current data for access by user systems.

Client systems 116-124 may access server 104 via collaboration, application/data sharing, or standard web browsers (e.g. Lotus Notes™—compliant software, HTML based or Java enabled web applications, etc.) located on client systems 116-124. Software may be Lotus Notes™ although it is not necessary in order to realize the advantages of the present invention.

Internal data storage of server 104 may comprise any form of mass storage device configured to read and write database type data maintained in a file store (e.g., a magnetic disk data storage device) and is logically addressable as a consolidated data source across a distributed environment such as system 100. The implementation of local and wide-area database management systems to achieve the functionality of the storage element will be readily understood by those skilled in the art.

A project database 114 is associated with server's 104 internal data storage and may be accessed by the project management optimization system 102 in order to implement activities described herein. Project database 114 stores information including project charter and scope, team members and other contacts, customer profiles, business process descriptions, business justifications, funding and resources, requirements, design, development and test data, task plans, project plans, information relating to communications management, change management, risk management, quality management, and supplier management, as well as lessons learned, project review meetings, executive review meetings, and project presentations. Information derived via the project management optimization system 102, also stored in project database 114, includes project details, inspection guidelines, results of risk assessments, project review criteria and assessments, reporting data, results of pareto analyses, and similar information. Project database 114 operates in a multi-project environment and provides a repository for each project to store the important information developed during the course of the project's life. Information stored in project database 114 is used to update project evaluation checklists and criteria resulting in a closed loop process of feedback back information from current projects to improve the checklists, criteria and measurements that will be applied to all new projects. Further, management personnel review information in project database 114 for relevant information, and audit teams review information for proper business controls regarding documentation, and providing consistency across multiple projects with respect to the information that should be recorded. This and other information related to activities conducted via the project management optimization system will be discussed further herein.

Project management optimization system 102 includes four components: a feedback structure 106, a self-correcting feature 108, an optimizing feature 110, and a feed-forward feature 112.

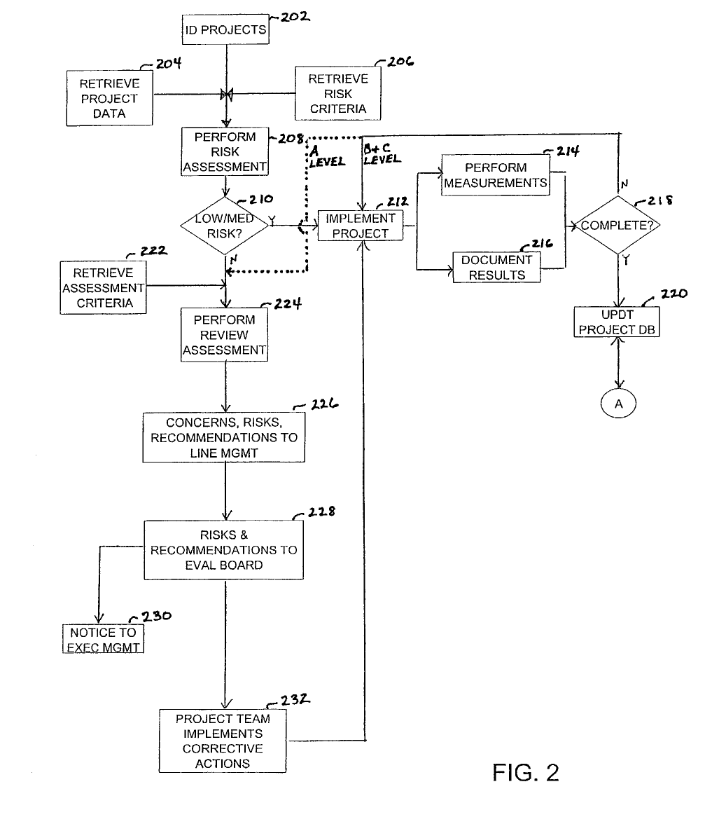

Feedback feature 106 provides visibility to the key diagnostic information relating to the reasons projects fail or indications of potential failures. This is accomplished in part by compiling information on the problems, root causes, and corrective actions that occur during the execution of projects. This information is generally provided by the project team members, as discussed further in FIG. 2, and can enable the present project team as well as succeeding teams to benefit from the experiences of the current team.

Self-correcting feature 108 refers to a repetitive process for developing and applying process measurements used for addressing potential root causes until a desired level of quality is achieved. The level of process detail at which in-line measurements are applied can be made lower and lower until a trade-off indicator establishes that the time spent in obtaining measurements at a specific level of detail outweighs the benefits of improved quality achieved via these measurements.

Optimizing feature 110 enables a determination to be made of the projects most likely to benefit from an independent review due to known or suspected increased risk factors such as highly complex projects and those of a large scale nature. This process of determining which projects are high risk is referred to herein as a “risk assessment.” The two main elements of the risk assessment procedure are the complexity of the project and the maturity of the implementing team in terms of skills and experience. The complexity element is a composite judgment of many aspects of the project including the technology, the plan and schedule, the number and location of development interfaces, the number and location of customers, the nature of the assumptions and dependencies, and similar criteria. The judgment of a team's maturity is a composite of many aspects of the skills and experience of the team. In addition to these basic considerations are such intangibles as leadership, teamwork and motivation which may be significant in this evaluation.

The risk assessment process is implemented using a complexity/maturity grid. The complexity/maturity grid is populated based upon judgments made for similar-type projects in order to get a calibration of the scale. Then the target project is positioned on the grid based upon its characteristics relative to the known projects. When the evaluation board identifies a specific project as having high potential risk, they request an in-depth review as described further herein.

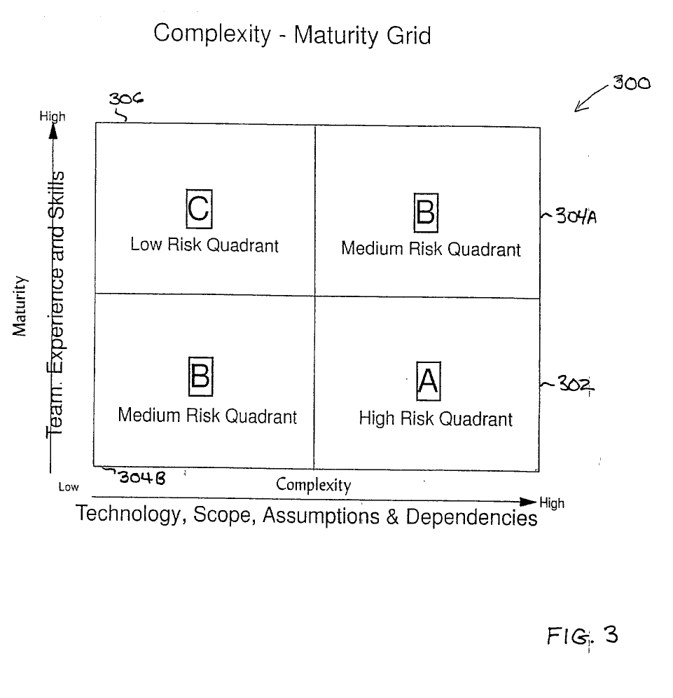

Generally, it would not be feasible to perform an in-depth review for every project contemplated by a business enterprise, so the ability to intelligently select the projects for detailed review is a feature which optimizes the use of resources that can be applied to this process. Thus, optimizing feature 110 includes the use of a complexity/maturity grid (see generally FIG. 3) for identifying the projects that have the highest potential for failure and that would benefit the most from a detailed review of their quality measures, performance, and other criteria for best practices in managing projects.

Feed forward feature 112 uses the information obtained from the initial risk assessment to affect in a constructive way the selection of resources with the correct skills and experience by line management, as well as identifying areas of risk for possible attention. This has the benefit of preventing problems down the road by anticipating and acting beforehand.

A framework for the flow of information associated with the implementation of the project management optimization system is described in FIG. 2. This process assumes that at least some baseline of established guidelines are already in place for the business enterprise. These guidelines are determined by the PM/T team at client system 120 and include inspection, measurements and sourcing or certification guidelines for future reference in evaluating projects.

The executive management personnel identify the projects they would like to implement for business reasons at step 202. A description of the project which includes relevant information such as a project name, project goal(s), information about the project team assigned, and information about the customer(s) associated with the project are stored in project database 114. These projects and their descriptions are passed onto the evaluation board at step 204. Relevant risk criteria is retrieved from project database 114 at step 206. A risk assessment is performed via optimization feature 110 whereby the evaluation team evaluates the complexity of the project and the skill/experience maturity of the implementing team at step 208. A complexity/maturity grid may be utilized for assessing the level of risk.

The complexity/maturity grid 300 of FIG. 3 includes four quadrants 302, 304A, 304B, and 306. The ‘y’ axis of grid 300 refers to the maturity component of the grid and relates to team experience and skills of the project team. The higher the rating on the ‘y’ axis, the less risk is involved with respect to the “team experience and skills” criteria. The ‘x’ axis refers to the complexity component of grid 300 and relates to technology, scope, assumptions, and dependencies. The higher the rating on the ‘x’ axis, the higher the assessed risk becomes with respect to the “technology, scope, assumptions, and dependencies” criteria. For example, sample criteria for high risk potential may include a project with multiple customers, anticipated high-cost projects, a project utilizing new technology, a project team's experience, and a project with an aggressive schedule. The evaluation of risk includes comparing the description information for the project against the criteria selected as potentially high risk. If the evaluation board determines that the project is low risk at step 210, it is assigned a review level of “C” and may be allowed to continue without an in-depth review. Level “C” projects can be an opportunity for developing the experience and skills required for higher risk projects. Level “B” projects are those considered to be at medium risk in that the maturity of the team is matched to complexity of the project. Similar to the “C” level risk projects, medium risk projects typically do not require any review to be completed prior to implementing the project. Thus, reviews other than by line management are not required for levels “B” and “C” projects.

The project team initiates execution of the project at step 212 and measurements of project status are acquired by line management or a project leader at step 214. Results of project measurements are documented at step 216. At step 218, it is determined whether the project, or project phase, task or the like is completed. If so, the results of the project are updated in project database 114 at step 220 for subsequent use by feedback feature 106. If the project has not completed, the process reverts to step 212 and the project execution is continued.

Alternatively, if the risk assessment is determined to be in a category that is considered to be high risk at step 210, then the PM/T team at client system 120 performs a project review assessment at step 224 according to the level of risk assigned. Level “A” projects have a high risk due to the complexity factors of a large scope, significant visibility or new technologies and are compounded by a lack of maturity in the team or individuals in dealing with these factors. High risk projects are those that have been determined to exceed a pre-established risk threshold and thus, require a minimum of three reviews. The first review is conducted prior to the completion of the project's proposal stage. The second review is held before completion of the final plan commitment stage. The third review occurs at design completion in the development stage. The proposal stage is when the initial proposal is in process. The final plan stage is when the final plan is in process. The development stage is when the design activity is underway.

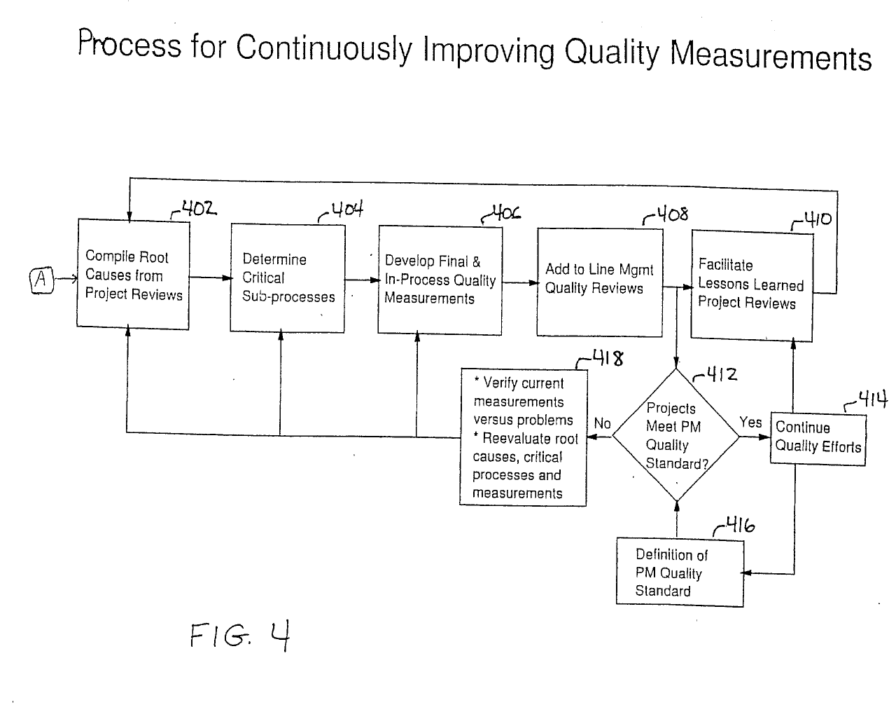

These project review assessments performed at step 224 are facilitated by information retrieved from project database 114 at step 222. Project database 114 stores pre-established assessment criteria. The review includes an independent project management/technology (PM/T) team, well versed in project management disciplines, meeting with the implementing project team to conduct a project management assessment. The project is assessed on how it addresses these criteria. The actual agenda of the review may vary considerably based upon the uniqueness of each project and the identified areas of risk concern. Based upon analyses performed as described in FIG. 4, it is likely that one or more sub-elements or review criteria of the project management process will be emphasized. These sub-elements are given more attention because they relate to common causes of project failures and are considered high potential risk areas. The approach then is to identify first those major components of projects which need to be in place to insure that the project is properly set up. A typical listing of these review items is shown as follows along with critical deliverables within each of these areas that demonstrate the proper focus of the project activities. For example, the following sample inspection criteria for determining project management capability may be determined. Within these key areas are shown sample critical deliverables.

Basic project management processes

Plan Development and Coordination

Project charter, overall plan, organization

Scope Management

scope document, requirements document, work breakdown structure, assumptions and dependencies

Schedule Management

project schedule, design document, test document, user acceptance criteria and verification test document, release contents document, rollout plan

Cost Management

cost estimate, budget plan

Quality Management

quality plan, checklists, lessons learned

Resource Management

staffing plan, roles and responsibilities:

completed skills/experience requirements

completed available skills/experience

identified gaps in skills/experience

Communication Management

communications plan, project documentation plan

Risk Management

risk assessment and mitigation plan

Supplier Management

dependency management plan

Known root causes of project failures

complete action list of relevant root causes

Recommended in-line quality measurements

are quality measurements being implemented

This assessment review criteria is stored in project database 114 and is updated continuously via self-correcting feature 108. A review summary is generated by the PM/T team. Concerns, risks, and recommendations resulting from the review process are transmitted to the line management via the feed forward feature 112 at step 226. For example, concerns may relate to project management issues, related technology issues, skills/experience assessments, etc. Other information includes root causes of problems reported and potential corrective actions. The noted risks and suggested recommendations are transmitted back to the evaluation board for review against the original risk assessment at step 228. The evaluation review board uses this information to complete the request they made for an in-depth review. This allows the evaluation board an opportunity to examine whether the recommendations fully address the initially defined risk and whether additional actions are necessary. Notification of any risks and recommendations are transmitted to the executive management personnel at step 230. The risks and recommendations are, in turn, transmitted to the project team at step 232. Armed with this new information, the project team implements the project at step 212 and the process described in steps 214-220 are repeated as necessary and utilized by feedback feature 106 to ensure continuous access to the key diagnostic information relating to the potential issues and/or failures that the project is exposed to. Additional reviews may be performed depending upon the nature and difficulty of the project. Thus, for level “A” projects that have not completed at step 218, the process reverts back to step 222 for a second, and possible third project assessment review.

The process steps described above can also be used when dealing with a supplier of services in an outsourced project environment. The project that is being subcontracted can be assessed for its complexity and the maturity of the supplier's team. Recommendations to conduct an in depth review of the supplier's capability as well as alert the supplier to areas of risk may be warranted.

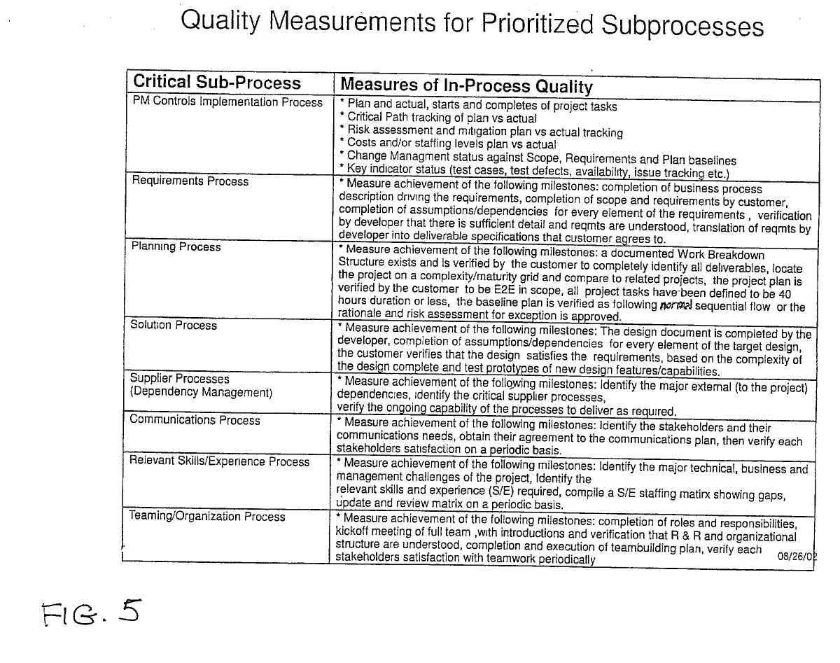

FIG. 4 is a flowchart illustrating the self-correcting feature of the project management optimization system. The PM/T team compiles the root causes from the project reviews implemented for a given project at step 402. The critical sub-processes are determined at step 404. The ‘final’ and ‘in-process’ quality measurements are developed at step 406. A sample set of critical sub-processes and corresponding measures of in-process quality criteria are shown in FIG. 5. FIG. 5 shows how the resulting improved measurements are turned over to line management for use in their reviews and how the feedback from lessons learned activities also provide input to the process. These measurements are added to line management quality reviews at step 408. Lessons learned and project reviews are facilitated at step 410. These process steps 402-410 may be repeated as necessary. Before lessons learned and project reviews are facilitated, a check to see which projects are meeting project management quality standards is performed at step 412. This is accomplished using the ‘quality standard’ definition specified by the business enterprise at step 416. If the projects meet the project management quality standards at step 412, the quality efforts are continued at step 414 and the process reverts to step 410 followed by 402. Also, the definition of project management quality standard is reviewed for continued accuracy as a basis for making these assessments at step 416. If the projects are not meeting project management quality standards at step 412, the PM/T team verifies current measurements compared to problems reported, and reevaluates root causes, critical processes and measurements at step 418. The process then reverts to one or more of steps 402-406. If the results of this analysis performed in FIG. 4 reveal a high risk potential exists in any of the processes or subprocesses noted in the project or in similar projects, this information is noted in project management database 114 so that the information used by the PM/T team in step 222 and 224 can be updated if necessary to more accurately perform future optimization of project risks.

As can be seen, this process allows project management personnel to drive down the defects in the project management process by early detection and to increase the awareness by the project manager of the types of defects and need for corresponding corrective action. The project management optimizing system permits a broader audience of individuals to become trained as project managers because the system presents opportunities and capabilities to measure and quantify the defects at any level of detail and in any area of the project management process.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for optimizing project management and quality assurance processes for a project, comprising:
performing a risk assessment analysis on project description data utilizing pre-established risk criteria;
if results of said risk assessment analysis indicate a project exceeds a pre-defined risk threshold:
performing a project review assessment utilizing pre-established assessment criteria;
generating a summary review including analysis data, conclusion data, and recommendations data based upon results of said project review assessment; and
transmitting summary review information to designated management personnel;
implementing said project;
documenting project execution data including noted problems, lessons learned, and solutions; and
storing said project execution data in a storage location.

2. The method of claim 1, further comprising:
developing and applying process measurements operable for addressing potential root causes until a desired level of quality is achieved, said desired level of quality determined by a cost benefit analysis comprising an amount of time spent in obtaining said process measurements at a specific level of detail and acquired benefits of improved quality achieved via said process measurements; and
utilizing said process measurements to implement corrective actions during execution of said project and future project executions.

3. The method of claim 2, wherein said specific level of detail at which said process measurements are applied are repetitively lowered in accordance with results of said cost benefit analysis, said process measurements including at least one of:
end of project measurements; and
in-process measurements.

4. The method of claim 1, wherein said designated management personnel include:
evaluation board personnel;
line management; and
executive management;
wherein said results of said project review assessment cause a project team to perform corrective actions relating to implementation of said project.

5. The method of claim 4, wherein said risk assessment analysis is performed via an evaluation board.

6. The method of claim 5, wherein said performing said risk assessment analysis includes generating a complexity/maturity grid for a current project, comprising:
populating said complexity/maturity grid with data based upon judgments made for projects similar to said current project in order to get a calibration of scale;
positioning data for said current project on said complexity/maturity grid based upon characteristics relative to said similar projects;
comparing risk data for said current project with said data populated on said complexity/maturity grid; and
based upon said comparing, assigning a risk level to said current project.

7. The method of claim 6, wherein said risk level assigned is at least one of:
a low risk, wherein said low risk requires no project review assessment prior to be executed for said project;
a medium risk, wherein said medium risk requires no project review assessment to be executed for said project; and
a high risk, wherein said high risk requires at least three project review assessments to be executed for said project.

8. The method of claim 1, wherein said pre-established risk criteria include at least one of:
multiple customers;
high project cost;
new technology;
inexperienced project team; and
aggressive project schedule.

9. The method of claim 1, wherein said project review assessment is performed by:
project management specialists; and
individuals possessing technical skills relevant to said project.

10. The method of claim 1, wherein said risk criteria is periodically reviewed and updated in a project database in accordance with results of project review assessments.

11. The method of claim 1, wherein said assessment criteria is periodically reviewed and updated in a project database in accordance with results of project review assessments.

12. A storage medium encoded with machine-readable computer program code for optimizing project management and quality assurance processes for a project, the storage medium including instructions for causing a computer to implement:
performing a risk assessment analysis on project description data utilizing pre-established risk criteria;
if results of said risk assessment analysis indicate a project exceeds a pre-defined risk threshold:
performing a project review assessment utilizing pre-established assessment criteria;
generating a summary review including analysis data, conclusion data, and recommendations data based upon results of said project review assessment; and
transmitting summary review information to designated management personnel;
implementing said project;
documenting project execution data including noted problems, lessons learned, and solutions; and
storing said project execution data in a storage location.

13. The storage medium of claim 12, further comprising instructions for causing said computer to implement:
developing and applying process measurements operable for addressing potential root causes until a desired level of quality is achieved, said desired level of quality determined by a cost benefit analysis comprising an amount of time spent in obtaining said process measurements at a specific level of detail and acquired benefits of improved quality achieved via said process measurements; and
utilizing said process measurements to implement corrective actions during execution of said project and future project executions.

14. The storage medium of claim 13, wherein said specific level of detail at which said process measurements are applied are repetitively lowered in accordance with results of said cost benefit analysis, said process measurements including at least one of:
end of project measurements; and
in-process measurements.

15. The storage medium of claim 12, wherein said designated management personnel include:
evaluation board personnel;
line management; and
executive management;
wherein said results of said project review assessment cause a project team to perform corrective actions relating to implementation of said project.

16. The storage medium of claim 15, wherein said risk assessment analysis is performed via an evaluation board.

17. The storage medium of claim 16, wherein said performing said risk assessment analysis includes generating a complexity/maturity grid for a current project, comprising:
populating said complexity/maturity grid with data based upon judgments made for projects similar to said current project in order to get a calibration of scale;
positioning data for said current project on said complexity/maturity grid based upon characteristics relative to said similar projects;
comparing risk data for said current project with said data populated on said complexity/maturity grid; and
based upon said comparing, assigning a risk level to said current project.

18. The storage medium of claim 17, wherein said risk level assigned is at least one of:
a low risk, wherein said low risk requires no project review assessment prior to be executed for said project;
a medium risk, wherein said medium risk requires no project review assessment to be executed for said project; and
a high risk, wherein said high risk requires at least three project review assessments to be executed for said project.

19. The storage medium of claim 12, wherein said pre-established risk criteria include at least one of:
multiple customers;
high project cost;
new technology;
inexperienced project team; and
aggressive project schedule.

20. The storage medium of claim 12, wherein said project review assessment is performed by:
project management specialists; and
individuals possessing technical skills relevant to said project.

21. The storage medium of claim 12, wherein said risk criteria is periodically reviewed and updated in a project database in accordance with results of project review assessments.

22. The storage medium of claim 12, wherein said assessment criteria is periodically reviewed and updated in a project database in accordance with results of project review assessments.

23. A system for optimizing project management and quality assurance processes for a project, comprising:
a project management optimization system comprising:
a feedback component;
a self-correcting component;
an optimizing feature;
a feed forward feature; and
a project database; and
a plurality of client systems operably coupled to said project management optimization system via a communications network.

24. The system of claim 23, wherein said optimizing feature includes a complexity/maturity grid.

25. The system of claim 24, where said project management optimization system performs analysis on project description data and pre-established risk criteria via said optimizing feature.

26. The system of claim 23, wherein said plurality of client systems are operated by:
executive management personnel;
evaluation board personnel;
project management/technical team personnel;
line management personnel and
project team personnel.

27. The system of claim 23, wherein said feedback component provides key diagnostic information relating to causes of project failures, said diagnostic information acquired by compiling information on problems, root causes, and corrective actions occurring during execution of projects.

28. The system of claim 23, wherein said self-correcting component includes a process operable for developing and applying process measurements for addressing root causes of a problem until a desired level of quality is achieved with respect to said project.

29. The system of claim 23, wherein said optimizing component evaluates risk factors associated with a project and assigns a risk level to said project.

30. The system of claim 23, wherein said feed forward component facilitates a selection of resources, appropriate skills and areas of risk using information obtained from a risk assessment.

31. The system of claim 23, wherein said project database stores project information comprising at least one of:
project description information;
inspection guidelines;
results of risk assessments;
project review assessment criteria;
project review assessments; and
reporting data.
